(19) United States
(12) Patent Application Publication
(10) Pub. No.: US 2004/0225430 A1
(43) Pub. Date: Nov. 11, 2004

(54) Method and device for controlling the shifting of an automatic transmission of a motor vehicle

(75) Inventors: Edgar Bothe, Peine (DE); Henning Muller, Gifhorn (DE); Klaus Leipnitz, Eckental (DE)

Correspondence Address: LERNER AND GREENBERG, PA, P O BOX 2480, HOLLYWOOD, FL, 33022-2480, US

(73) Assignee: Volkswagen Aktiengesellschaft

(21) Appl. No.: 10/847,499

(22) Filed: May 17, 2004

Related U.S. Application Data
(63) Continuation of application No. PCT/EP02/11994, filed on Oct. 26, 2002.

(30) Foreign Application Priority Data
Nov. 23, 2001 (DE) 101 57 393.6

(51) Int. Cl. G06F 17/00

(52) U.S. Cl. 701/52

(57) ABSTRACT

A method for controlling the shifting of a transmission uses a control device for shifting gears in two different operating modes. In a first operating mode, the transmission is operated in an automatic mode and the shifting is automatically carried out, essentially based on detected driving parameters and with the aid of the control device. A respective automatic driving program and/or a respective top selectable gear can be selected in the automatic mode. In a second operating mode, the transmission is operated according to an automated manual shifting mode by using an actuating device. The respective automatic driving program and/or the respective top selectable gear can be selected by using the actuating device when the transmission is in the automatic mode. A device for controlling the shifting of a transmission is also provided.

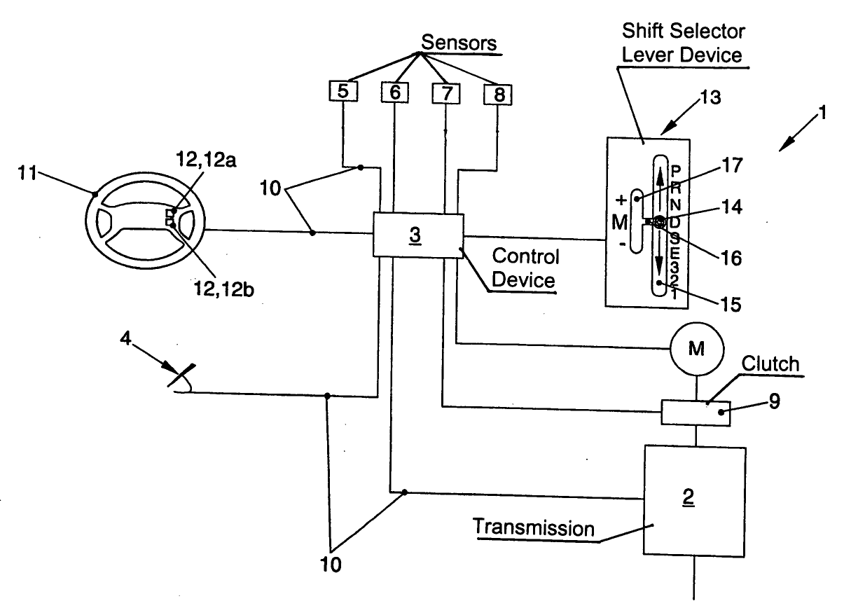

### CROSS-REFERENCE TO RELATED APPLICATION

This application is a continuation, under 35 U.S.C. § 120, of copending International Application No. PCT/EP02/11994 filed Oct. 26, 2002, which designated the United States; this application also claims the priority, under 35 U.S.C. § 119, of German Patent Application No. 101 57 393.6, filed Nov. 23, 2001; the prior applications are herewith incorporated by reference in their entirety.

### BACKGROUND OF THE INVENTION

1. Field of the Invention

The invention relates to a method for controlling the shifting of an automatic transmission or an automated transmission of a motor vehicle. The shifting of the transmission is realized in two different operating modes with the aid of a control device. In a first operating mode, the transmission is operated in an automatic mode, and the shifting is realized automatically substantially based on detected driving parameters and with the aid of the control device, wherein, in the automatic mode, a respective automatic drive program and/or a respective top gear can be selected. In a second operating mode, the transmission is operated in the automated manual shift mode, and the shifting is realized with the aid of the control device and an actuating device that can be operated manually by the driver.

The invention also relates to a device for controlling the shifting of an automatic transmission or an automated transmission of a motor vehicle, particularly one that functions according to the abovementioned method. The shifting of the transmission in two different operating modes can be realized with the aid of a control device. In a first operating mode, the transmission can be operated in an automatic mode, and the shifting can be realized automatically substantially by detected driving parameters and with the aid of the control device, but the respective automatic drive program or the respective top gear that can be set is definable or selectable. In a second operating mode, the transmission can be operated in automated manual shift mode, and the shifting can be realized with the aid of the control device and an actuating device that can be manually operated by the driver.

European Patent Application No. EP 1 039 178 A2 discloses a device and a method for controlling the shifting of an automatic transmission, wherein an actuating device, particularly a rocker switch, is disposed at the steering wheel so that the driver can realize the corresponding upshifting and downshifting manually in a manual shift mode. The actuating device that is disposed at the steering wheel is also often referred to as a “TIPTRONIC” shift/device. If the transmission is being operated in automatic mode, it is possible to temporarily disengage the automatic mode by actuating the switch elements at the steering wheel, specifically in order to activate the manual shift mode by using the switches of the actuating device, so that the driver can perform the shifting, i.e. the individual gear changes in the transmission, manually with the switches disposed at the steering wheel. The restoration of the automatic mode occurs after a defined preset time or is triggered by a “kickdown” at the gas pedal. In the conventional method and device herein described, an alternation between automatic mode and manual shift mode is realized by using the corresponding actuating device. A similar device and method are also described in Published, Non-Prosecuted German Patent Application No. DE 43 11 886 A1.

Conventional automated transmissions can be operated in an automatic mode or in a manual mode. The driver can select which mode to drive in. In order to realize the manual shifting mode, a shift selector lever is provided, which can be moved in a first shift gate and also in a second shift gate, namely for realizing the corresponding manual shift mode. In the first shift gate, the shift selector lever is movable into various positions, e.g. positions P, R, N and D, wherein the shift selector lever is movable into the second shift gate, particularly through the use of a specially provided transverse gate, and then in the second shift gate into the positions “+” and “−” in order to realize the corresponding upshift and downshift in the manual mode. Conventional transmissions may also contains actuating devices for realizing the manual mode that are provided at the steering wheel, particularly either two separate switches for shifting the gears up and down, or a single switch which is constructed as a rocker switch with the aid of which the corresponding upshifting and downshifting can be realized.

A common feature of all these devices and methods is that the driver must decide whether to drive in automatic mode; i.e., gear changes in the transmission are realized automatically through the use of the control device based on the corresponding driving parameters such as gas pedal position and so on, or to drive the vehicle in manual mode, for which the driver has to activate this mode accordingly. Mostly the driver can either activate this manual mode through the use of the shift selector lever, which the driver must move into the corresponding position “M”, i.e. into the second shift gate, after which the corresponding upshifting and downshifting can be performed. But it is also possible to change from a pure automatic mode to manual mode by activating the corresponding switches that are provided in the steering wheel area.

The conventional methods and devices for controlling the shifting of an automatic transmission are not optimal. The vehicle, that is to say the transmission, can be operated or driven in the first mode, namely the automatic mode; however, there are a variety of automatic modes, namely different automatic drive programs such as a comfort drive program, a sport drive program, and/or an economy drive program. In other words, the driver can select a particular drive program by setting the shift selector lever accordingly, and the vehicle (i.e. the transmission) will still be operated in automatic mode according to this selected drive program. At the same time, the driver has the ability to determine or define a gear as the top gear to be used in the transmission by setting the shift selector lever accordingly. Limiting gear selection in this manner is particularly important for downhill driving. For example, if the transmission is constructed as a 5-speed or 6-speed transmission, and the driver would like to perform downhill driving, the driver has the ability to limit the top gear accordingly, for instance to third gear, so that the driver can use the engine as a brake to slow down the vehicle. It is also entirely possible to set the limit at fourth gear or at second or first gear. The selection of the top selectable gear is up to the driver's judgment. A disadvantage of the conventional methods and devices is that, when the transmission (the vehicle) is operated in automatic mode, the driver must remove his or her hands from the steering wheel in order to set the specific drive program that the driver wants or in order to select the corresponding top gear for downhill driving, by using the shift selector lever. In other words, the driver must move the shift selector lever into the corresponding position in order to define the specific drive program or corresponding top gear in automatic mode. This requires the driver to perform additional work which complicates operation and is also inconvenient.

### SUMMARY OF THE INVENTION

It is accordingly an object of the invention to provide a method and a device for controlling a shifting of a transmission which overcome the above-mentioned disadvantages of the heretofore-known methods and devices of this general type and which make it easier to control the shifting, particularly with respect to setting specific settings within the automatic mode.

With the foregoing and other objects in view there is provided, in accordance with the invention, a method for controlling a shifting of a transmission, which includes the steps of:

implementing a shifting of a transmission by using a control device such that the shifting is selectively performed in a first operating mode and a second operating mode;

operating the transmission in an automatic mode, when performing the shifting in the first operating mode, such that, in the automatic mode, a drive program is selectable and the shifting is performed automatically substantially based on detected driving parameters and by using the control device, wherein the drive program is a program selected from the group consisting of at least one automatic drive program and at least one drive program having a top selectable gear;

operating the transmission in an automated manual shift mode, when performing the shifting in the second operating mode, such that the shifting is implemented by the control device and an actuating device to be operated manually by a driver; and

providing at least one device selected from the group consisting of the control device and the actuating device in terms of a respective control engineering such that, when the transmission operates in the automatic mode, the drive program is selectable with the actuating device.

In other words, according to the invention, there is provided a method for controlling the shifting of an automatic transmission or an automated transmission of a motor vehicle according to which the shifting of the transmission is realized in two different operating modes by using a control device; namely, in a first mode the transmission is operated in automatic mode, and the shifting is realized automatically substantially by detected driving parameters and with the aid of the control device, but wherein, in automatic mode, the respective automatic drive program (D, S, E) and/or the respective top gear is definable or selectable, and in a second operating mode the transmission is operated in an automated manual shift mode, and shifting is realized by the control device and an actuating device that can be operated manually by the driver, wherein the actuating device and/or the control device are configured and/or constructed such that the respective automatic drive program and/or the respective top gear are selectable through the use of the actuating device while the transmission is operated in automatic mode.

Another mode of the method according to the invention includes providing at least a sport drive program and an economy drive program as automatic drive programs for the automatic mode.

A further mode of the method according to the invention includes providing the transmission as a 5-speed transmission or a 6-speed transmission with a relatively lower gear and a relatively higher gear; and using the relatively lower gear as the top selectable gear when operating the transmission in the automatic mode. In other words, the respective top gear in automatic mode is set so as to limit it to one of the lower gears.

Another mode of the method according to the invention includes providing the transmission as a 5-speed transmission or a 6-speed transmission with a relatively lower gear and a relatively higher gear; setting the relatively lower gear as the top selectable gear when operating the transmission in the automatic mode; and subsequently setting, with the actuating device, the relatively higher gear as the top selectable gear. In other words, if the top gear in automatic mode has been set so that it is limited to one of the lower gears, it can subsequently be reset back to one of the higher gears by using the actuating device.

Yet another mode of the method according to the invention includes providing the transmission with a relatively lower gear and a relatively higher gear; providing a limitation for the automatic mode by setting the relatively lower gear as the top selectable gear; and canceling the limitation of using the relatively lower gear as the top selectable gear in case of an actuation of the actuating device for a given period, reaching a given minimum vehicle speed, reaching a maximum period of using the relatively lower gear as the top selectable gear, or an occurrence of a given driving behavior of a driver.

Another mode of the method according to the invention includes using, as the transmission, an automatic or an automated transmission of a motor vehicle.

With the objects of the invention in view there is also provided, in combination with a transmission, a device for controlling a shifting of the transmission, including:

a control device for controlling a shifting of the transmission selectively in a first operating mode and a second operating mode;

sensors operatively connected to the control device;

the control device, when controlling the shifting of the transmission in the first operating mode, operating the transmission in an automatic mode such that a drive program is selectable and such that the control device controls the shifting automatically substantially based on detected driving parameters, wherein the drive program is a program selected from the group consisting of at least one automatic drive program and at least one drive program having a top selectable gear;

an actuating device to be operated manually by a driver, the actuating device being operatively connected to the control device;

the control device operating the transmission in an automated manual shift mode, when performing the shifting in the second operating mode, such that a shifting is controlled by the control device and the actuating device; and

at least one of the actuating device and the control device being configured in terms of a respective control engineering such that, when the transmission operates in the automatic mode, the drive program is selectable with the actuating device.

In other words, according to the invention, there is provided, a device for controlling the shifting of an automatic transmission or an automated transmission of a motor vehicle, in particular according to the method of the invention, wherein the shifting of the transmission is realized in two different operating modes through the use of a control device; namely, in a first mode the transmission is operable in automatic mode, and the shifting is realized automatically substantially by detected driving parameters and with the aid of the control device, but wherein, in automatic mode, the respective automatic drive program (D, S, E) and/or the respective top gear is definable or selectable, and in a second operating mode the transmission is operated in an automated manual shift mode, and shifting can be realized through the use of the control device and an actuating device that can be operated manually by the driver, wherein the actuating device and/or the control are configured and/or constructed in such a way that the respective automatic drive program and/or the respective top gear that can be set are selectable through the use of the actuating device while the transmission is operable or operated in automatic mode.

According to another feature of the invention, the control device, when operating the transmission in the automatic mode, provides at least a sport drive program and an economy drive program as the at least one automatic drive program.

According to yet another feature of the invention, the transmission is a 5-speed transmission or a 6-speed transmission with relatively lowers gear and a relatively higher gear; and the actuating device is configured to be operated manually for setting one of the relatively lower gears as the top selectable gear when operating the transmission in the automatic mode.

According to another feature of the invention, the actuating device is configured to be operated manually for changing the top selectable gear from the relatively lower gear back to the relatively higher gear when operating the transmission in the automatic mode.

According to a further feature of the invention, the control device is configured to cancel a limitation of the top selectable gear to one of the lower gears when the actuating device is actuated for a given period, when reaching a given minimum vehicle speed, when reaching a maximum period of using one of the lower gears as the top selectable gear, and when a given driving behavior of a driver occurs.

According to another feature of the invention, a shift selector lever is operatively connected to the control device; and the shift selector lever is movable into given positions in the shift gate.

According to another feature of the invention, the actuating device is disposed at the steering wheel, for example mounted on the steering wheel or close to the steering wheel.

According to a further feature of the invention, the actuating device includes a first switch for a manual upshifting of the transmission and a second switch for a manual downshifting of the transmission.

According to another feature of the invention, the actuating device includes a rocker switch for performing a manual shifting.

According to another feature of the invention, the actuating device includes a switch for realizing a changeover between the automatic mode and the automated manual shift mode.

According to yet another feature of the invention, the control device is configured to control the shifting of an automatic transmission or the shifting of an automated transmission.

The method and device according to the invention, substantially increase the shifting comfort for the driver. Now it is possible, when the transmission is in automatic mode, to select the specific drive program for automatic mode and/or, for downhill driving in particular, simultaneously to set the respective top gear according to the driver's wishes through the use of the actuating device with which upshifting and downshifting are performed in manual mode. If this actuating device is disposed in the steering wheel region, the driver need not remove his or her hands from the steering wheel in order to change the respective drive program, for instance from the comfort drive program to the sport drive program or the economy drive program, while remaining in the automatic transmission mode. The same is true for setting or limiting the respective top selectable gear. As a result, the abovementioned disadvantages are eliminated, and a convenient shifting capability is realized for the driver.

Other features which are considered as characteristic for the invention are set forth in the appended claims.

Although the invention is illustrated and described herein as embodied in a method and a device for controlling the shifting of an automatic transmission of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single FIGURE is a schematic representation of an exemplary layout of components of the device according to the invention for realizing the method according to the invention.

### DESCRIPTION OF THE PREFERRED EMBODIMENTS

The single FIGURE of the drawing schematically illustrates critical components of a device 1 for carrying out the method according to the invention. The motor vehicle itself is only partially represented by its automated transmission or automatic transmission 2, wherein the shifting of transmission 2 is realized with the aid of the control device 3 and actuators that are disposed within the transmission 2. The transmission 2 can be operated in a first operating mode, namely automatic mode; that is, the control device 3, which is constructed on an electronic/electric basis, takes over the corresponding control processes for performing the corresponding gear shift of the transmission 2 based on drive parameters that are detected or inputted, such as the position of gas pedal 4 and other parameters that are detected by the sensors 5 to 8 that are schematically represented, for instance speed of travel, r.p.m. of the input and output shafts of the transmission 2, engine r.p.m. and so on. The control device 3 also controls the shifting, i.e. the opening and closing operations of the clutch 9. To that end, corresponding actuators are provided in the region of the clutch 9. The actuators of the transmission 2 and the clutch 9 are realized on an electric basis but can also be realized on a hydraulic basis.

The critical components of device 1 are interconnected by control lines 10, which are schematically represented. In particular, the control device 3 is additionally connected to the actuating device 12 that is disposed in the region of steering wheel 11 as well as to a shift selector lever device 13 that is disposed on the center console of the motor vehicle.

The shift selector lever device 13 includes a shift selector lever 14 that is movable in a first shift gate 15 into defined positions, here at least into positions “P” (park), “R” (reverse), “N” (neutral), “D” (forward, comfort drive program), “S” (sport drive program), “E” (economy drive program) and positions “3”, “2”, and “1”. The shift selector lever 14 is also movable by way of a cross-gate 16 into a second shift gate 17, namely into position M, in order to be able to realize a manual upshifting in position “+” and a manual downshifting in position “−” with the help of the control device 3 within the transmission 2.

As represented schematically in the layout diagram of the single figure, the automatic transmission or automated transmission 2 represented there can be operated in a first mode, namely in the automatic mode. The term “automatic mode” refers to the settings “D”, “S”, “E” and “3”, “2”, and “1” of the shift selector lever 14. This means that in automatic mode different drive programs which are stored in the control device 3 can be selected by the driver accordingly; i.e., given corresponding shifting of the shift selector lever 14 into position 3 in the first shift gate 15, for example, the respective top gear of the transmission can be limited to third gear (or second or first gear by moving the shift selector lever 14 into position “2” or “1”). The various drive programs can be stored in the control device 3 as operating maps or input-output maps for shifting. The corresponding characteristic curves for upshifting and downshifting for the automatic mode can be similarly stored.

Besides this, as can be seen from the figure, the represented transmission 2 can also be operated in another operating mode, namely a second operating mode, the automated manual shift mode, which differs from the first operating mode. This means that the corresponding gears in the transmission can be shifted up and down manually by moving the shift selector lever 14 across the cross-gate 16 into the second shift gate 17, i.e. into the positions for manual shifting “M”, and by moving the shift selector lever 14 in corresponding fashion into the position “+” or “−”. This is also possible with the actuating device 12 that is disposed in the region of the steering wheel 11. To that end, the actuating device 12 includes corresponding switches 12a and 12b, so that a corresponding upshifting and downshifting in the transmission 2 can be accomplished in manual shift mode with the aid of switches 12a and 12b. The manual shift mode can be activated either by moving the shift selector lever 14 into position “M” or by pressing and holding one of the switches 12a and 12b for an extended period of time. An additional switch for realizing the changeover from automatic to manual modes (and vice versa) may conceivably also be disposed in the region of the steering wheel 11.

With respect to the method of controlling the shifting of a transmission, the above described disadvantages are avoided by the actuating device 12 and/or the control being configured and/or constructed in terms of the control engineering in such a way that the respective automatic drive program and/or the respective top gear is selectable through the use of the actuating device 12 while the transmission 2 is in automatic mode. Therefore, in order to avoid the disadvantages, the device 1 is constructed such that the actuating device 12 and/or the control are configured and/or constructed in terms of the control engineering in such a way that the respective automatic drive program and/or top gear is selectable through the use of the actuating device 12 while the transmission is operable or operated in automatic mode.

Decisive advantages are achieved by the control and the device 1 so realized; in particular, the specific drive programs and/or, for downhill driving in particular, a respective top selectable gear can be set or selected in the transmission 2, while the automatic mode is still in effect, through the use of the same actuating device 12 with which the manual shift mode is operated. The driver need not remove his or her hands from the steering wheel 11 and can change the specific drive programs of the automatic mode and/or select a corresponding top selectable gear, while the automatic mode is in effect, through the use of the actuating device 12 that is already provided at the steering wheel. The driver can thus select various automatic drive programs with the aid of the actuating device 12, namely sport drive “S”, economy drive “E”, or “normal” comfort drive “D”. To accomplish this, the gear shifting mechanism can be configured such that, when in automatic mode, these specific automatic drive programs can be selected by actuation of the switch buttons 12a or 12b, and the actuation of switches 12a and 12b does not achieve a changeover directly into manual shift mode. For example, the shifting mechanism or the actuating device 12 can be configured such that, if the transmission 2 is a 6-speed or 5-speed transmission or even a 4-speed transmission, the top selectable gear that can be set in automatic mode is limited to one of the lower gears. This means that for downhill driving, for instance, the third gear of the transmission 2 is the maximum gear that can be engaged, so that the engine brake can be used accordingly. On one hand, after such a setting has been performed through the use of the actuating device 12, it is still possible to reset to one of the upper gears again by canceling the top gear limitation, in particular if it is for example not opposed by the minimal hysteresis of the corresponding characteristic curve for shifting. This is possible with the represented actuating device 12 but can also be realized automatically with the aid of the control device 3; for example, the limitation of the top selectable gear to one of the lower gears can be cancelled under specified conditions, for instance if the actuating device 12 is actuated for a predetermined period (e.g. longer than 1 second), or if the vehicle achieves a certain minimum speed, or if the limitation to a lower gear has been in effect for a certain maximum period of time. A specific driving behavior of the driver, such as a “kickdown” with the gas pedal 4, can also cancel the limitation.

The limitation of the top gear to a specified lower gear can in particular be cancelled through the use of the control device 3. The control device 3 accordingly includes the requisite electronic components such as a timer in order to interrogate and realize the corresponding above mentioned conditions. Additional components can also be provided in order to develop the method and device according to the invention still further. It has already been mentioned that the actuating device 12 can include additional switches. Besides this, the switches 12a and 12b of the actuating device 12 can for example also be replaced by a rocker switch. Additional displays can be disposed in the region of steering wheel 11, with which the driver can read which drive program within the automatic mode he or she has just shifted into or which gear the driver has selected as top gear. Visual perception enhances the shifting comfort for the driver.

It is of critical importance that the automatic mode can also be influenced at the same time, i.e. while the automatic mode is still in effect, through the use of the actuating device 12 with which only the manual mode was operated in conventional methods and devices; in this case, the corresponding specific automatic drive programs can be selected by the driver and/or a respective top gear to be engaged in the transmission 2 can be defined, without the driver having to move the shift selector lever 14. The integration of the actuating device 12 into the circuit configuration in accordance with the invention increases driving comfort.

We claim:

1. A method for controlling a shifting of a transmission, the method which comprises:
implementing a shifting of a transmission by using a control device such that the shifting is selectively performed in a first operating mode and a second operating mode;
operating the transmission in an automatic mode, when performing the shifting in the first operating mode, such that, in the automatic mode, a drive program is selectable and the shifting is performed automatically substantially based on detected driving parameters and by using the control device, wherein the drive program is a program selected from the group consisting of at least one automatic drive program and at least one drive program having a top selectable gear;
operating the transmission in an automated manual shift mode, when performing the shifting in the second operating mode, such that the shifting is implemented by the control device and an actuating device to be operated manually by a driver; and
providing at least one device selected from the group consisting of the control device and the actuating device in terms of a respective control engineering such that, when the transmission operates in the automatic mode, the drive program is selectable with the actuating device.

2. The method according to claim 1, which comprises providing at least a sport drive program and an economy drive program as automatic drive programs for the automatic mode.

3. The method according to claim 1, which comprises:
providing the transmission as a 5-speed transmission or a 6-speed transmission with a relatively lower gear and a relatively higher gear; and
using the relatively lower gear as the top selectable gear when operating the transmission in the automatic mode.

4. The method according to claim 1, which comprises:
providing the transmission as a 5-speed transmission or a 6-speed transmission with a relatively lower gear and a relatively higher gear;
setting the relatively lower gear as the top selectable gear when operating the transmission in the automatic mode; and subsequently setting, with the actuating device, the relatively higher gear as the top selectable gear.

5. The method according to claim 1, which comprises:
providing the transmission with a relatively lower gear and a relatively higher gear;
providing a limitation for the automatic mode by setting the relatively lower gear as the top selectable gear; and
canceling the limitation of using the relatively lower gear as the top selectable gear in case of a condition selected from the group consisting of actuation of the actuating device for a given period, reaching a given minimum vehicle speed, reaching a maximum period of using the relatively lower gear as the top selectable gear, and occurrence of a given driving behavior of a driver.

6. The method according to claim 1, which comprises using, as the transmission, an automatic transmission of a motor vehicle.

7. The method according to claim 1, which comprises using, as the transmission, an automated transmission of a motor vehicle.

8. In combination with a transmission, a device for controlling a shifting of the transmission, comprising:
a control device for controlling a shifting of the transmission selectively in a first operating mode and a second operating mode;
sensors operatively connected to said control device;
said control device, when controlling the shifting of the transmission in the first operating mode, operating the transmission in an automatic mode such that a drive program is selectable and such that said control device controls the shifting automatically substantially based on detected driving parameters, wherein the drive program is a program selected from the group consisting of at least one automatic drive program and at least one drive program having a top selectable gear;
an actuating device to be operated manually by a driver, said actuating device being operatively connected to said control device;
said control device operating the transmission in an automated manual shift mode, when performing the shifting in the second operating mode, such that a shifting is controlled by said control device and said actuating device; and
at least one of said actuating device and said control device being configured in terms of a respective control engineering such that, when the transmission operates in the automatic mode, the drive program is selectable with the actuating device.

9. The device according to claim 8, wherein said control device, when operating the transmission in the automatic mode, provides at least a sport drive program and an economy drive program as the at least one automatic drive program.

10. The device according to claim 8, wherein:
the transmission is a 5-speed transmission or a 6-speed transmission with relatively lowers gear and a relatively higher gear; and
said actuating device is configured to be operated manually for setting one of the relatively lower gears as the top selectable gear when operating the transmission in the automatic mode.

11. The device according to claim 8, wherein:
the transmission is a 5-speed transmission or a 6-speed transmission with a relatively lower gear and a relatively higher gear; and
said actuating device is configured to be operated manually for changing the top selectable gear from the relatively lower gear back to the relatively higher gear when operating the transmission in the automatic mode.

12. The device according to claim 8, wherein:
the transmission has relatively lower gears and a relatively higher gear; and
said control device is configured to cancel a limitation of the top selectable gear to one the relatively lower gears upon occurrence of a condition selected from the group consisting of actuation of the actuating device for a given period, reaching a given minimum vehicle speed, reaching a maximum period of using the one of the relatively lower gears as the top selectable gear, and occurrence of a given driving behavior of a driver.

13. The device according to claim 8, including:
a shift selector lever operatively connected to said control device; and
a shift gate, said shift selector lever being movable into given positions in said shift gate.

14. The device according to claim 8, including a steering wheel, said actuating device being disposed at said steering wheel.

15. The device according to claim 8, wherein said actuating device includes a first switch for a manual upshifting of the transmission and a second switch for a manual downshifting of the transmission.

16. The device according to claim 8, wherein said actuating device includes a rocker switch for performing a manual shifting.

17. The device according to claim 8, wherein said actuating device includes a switch for realizing a changeover between the automatic mode and the automated manual shift mode.

18. The device according to claim 8, wherein said control device is configured to control the shifting of an automatic transmission as the transmission.

19. The device according to claim 8, wherein said control device is configured to control the shifting of an automated transmission as the transmission.
